(19) United States
(12) Patent Application Publication
(10) Pub. No.: US 2014/0364062 A1
(43) Pub. Date: Dec. 11, 2014

(54) COMMUNICATION SYSTEM, SPECIFICATION METHOD, AND RECORDING MEDIUM

(71) Applicant: Sharp Kabushiki Kaisha, Osaka (JP)

(72) Inventor: Shoji KOARAI, Osaka-shi (JP)

(73) Assignee: Sharp Kabushiki Kaisha, Osaka (JP)

(21) Appl. No.: 14/250,761

(22) Filed: Apr. 11, 2014

(30) Foreign Application Priority Data
Jun. 7, 2013 (JP) 2013-121138

(51) Int. Cl. H04B 7/26

(52) U.S. Cl. CPC H04B 7/26
USPC 455/41.2

(57) ABSTRACT

Disclosed is a communication system including a plurality of communication terminals having their own position information and performing communication between the communication terminals, wherein one communication terminal determines a specific direction, and specifies a target communication terminal which is to be a communication target with its own terminal, based on the determined direction and position information from the other communication terminals.

### CROSS-REFERENCE TO RELATED APPLICATIONS

This Nonprovisional application claims priority under 35 U.S.C. §119(a) on Patent Application No. 2013-121138 filed in Japan on Jun. 7, 2013, the entire contents of which are hereby incorporated by reference.

### FIELD

The present invention relates to a communication system which includes a plurality of communication terminals having their own position information and performs communication between the communication terminals.

### BACKGROUND

Recently, a communication system which includes a plurality of communication terminals connected to a network in a wired or wireless manner and performs communication between the communication terminals within the network has been widely propagated.

However, in the environment that the communication with the plurality of communication terminals may be made, when a user wants to transmit data to any one of the communication terminals, that is, when a user wants to designate one destination, the user may not easily perform an operation of selecting one of the plurality of communication terminals.

The reason is that, in most of the communication terminals, when the user selects the destination, all the communication terminals which are registered in its own terminal or may access its own terminal are displayed on a display unit and these communication terminals are displayed by using a terminal name, IP address or the like.

To solve the above problem, Japanese Patent Laid-Open Publication No. 2010-199753 discloses a portable terminal in which when its own portable terminal faces toward a user as a communication partner to search for telephone directory information, the communication partners whose telephone directory information is registered in the portable terminal and who exist in a vector direction shown by a direction of the portable terminal are searched as a candidate of a screen display, and the telephone directory information on the user as the searched communication partner is displayed on a screen of a display unit of the portable terminal.

### SUMMARY

However, in the portable terminal disclosed in Japanese Patent Laid-Open Publication No. 2010-199753, there is a need to register a target to be searched as the telephone directory information in advance and exclude users who are not registered from the target to be searched. Further, when the target to be searched is a mobile body, the portable terminal disclosed in Japanese Patent Laid-Open Publication No. 2010-199753 may not properly cope with the mobile body.

In consideration of the above-mentioned circumstances, it is an object of the present invention to provide a communication system which includes a plurality of communication terminals having their own position information and performs communication between the communication terminals, in which one communication terminal is configured to determine a specific direction and specify a target communication terminal which is to be a communication target with its own terminal, based on the determined direction and position information from other communication terminals, thereby enabling a user to easily select a communication terminal of a communication partner to be communicated therewith, preventing an error, such as unintendedly transmitting data to others by mistake, alleviating a burden on an operation of selecting the communication terminal of the communication partner to be communicated therewith, and more intuitively operating the communication terminal.

According to one aspect of the present invention, there is provided a communication system including a plurality of communication terminals having their own position information and performing communication between the communication terminals, wherein one communication terminal includes: a direction determination unit configured to determine a specific direction; and a target specification unit configured to specify a target communication terminal which is to be a communication target with its own terminal, based on the determined direction and position information of other communication terminals acquired from the other communication terminals.

In the communication system according to the present invention, the one communication terminal includes a direction detection unit configured to detect a direction of its own terminal, and the direction determination unit determines a direction based on a result detected by the direction detection unit.

In the communication system according to the present invention, the one communication terminal includes a calculation unit configured to calculate the distance to the other communication terminals based on the position information from the other communication terminals, and the target specification unit specifies the target communication terminal based on the distance calculated by the calculation unit, the direction determined by the direction determination unit, and the position information from the other communication terminals.

In the communication system according to the present invention, the one communication terminal includes a position relation display control unit configured to display a relation between direction and distance between the target communication terminal specified by the target specification unit and its own terminal.

In the communication system according to the present invention, in the one communication terminal, when a plurality of target communication terminals are specified by the target specification unit, the position relation display control unit displays each of the target communication terminals by associating different colors thereto depending on the distances from its own terminal.

According to the communication system of the present invention, a user may easily select a communication terminal of a communication partner to be communicated therewith, and an error such as unintendedly transmitting data to others by mistake may be prevented, thereby a burden on an operation of selecting the communication terminal of the communication partner to be communicated therewith may be alleviated, and the user may more intuitively operate the communication terminal.

The above and further objects and features will more fully be apparent from the following detailed description with accompanying drawings.

### BRIEF DESCRIPTION OF THE DRAWINGS

FIG. 1 is a conceptual diagram illustrating a communication system according to Embodiment 1 of the present invention;

FIG. 2 is a functional block diagram illustrating a configuration of main parts of a communication terminal of the communication system according to Embodiment 1 of the present invention;

FIG. 3 is a functional block diagram illustrating a configuration of main parts of a control unit in the communication terminal of the communication system according to Embodiment 1 of the present invention;

FIG. 4 is a flow chart illustrating processing associated with specifying target communication terminals and displaying a position relation between the target communication terminals in the communication terminal of the communication system according to Embodiment 1 of the present invention;

FIG. 5 is an exemplified diagram illustrating an example of a data transmission function selection screen which is displayed on the communication terminal of the communication system according to Embodiment 1 of the present invention;

FIG. 6 is an exemplified diagram illustrating an example of a position relation displayed by a position relation display unit in the communication terminal of the communication system according to Embodiment 1 of the present invention; and

FIG. 7 is an exemplified diagram illustrating an example of a position relation displayed by a position relation display unit in a communication terminal of a communication system according to Embodiment 2 of the present invention.

### DETAILED DESCRIPTION OF NON-LIMITING EXAMPLE EMBODIMENTS

Hereinafter, a communication system according to embodiments of the present invention will be described in detail with reference to the accompanying drawings.

### Embodiment 1

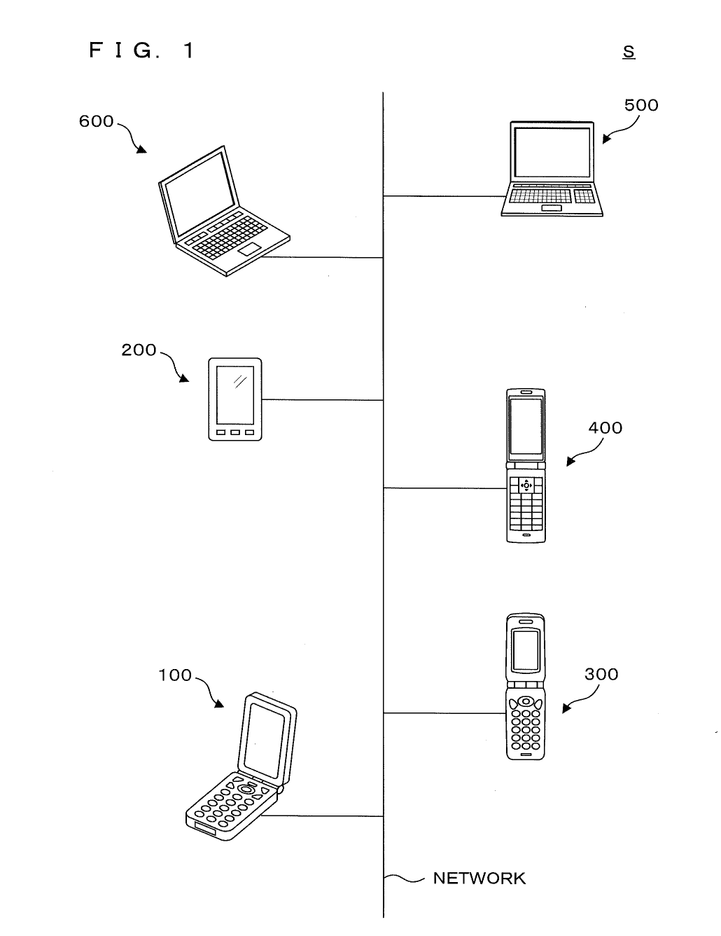

FIG. 1 is a conceptual diagram illustrating a communication system S according to Embodiment 1 of the present invention. The communication system S according to the present invention includes a plurality of communication terminals 100 to 600 connected to each other through a network to be able to communicate with each other. In the following description, for convenience of explanation, a case in which data are transmitted from the communication terminal 100, which is a mobile phone, to other communication terminals 200, 300, 400, 500, and 600 will be described by way of example.

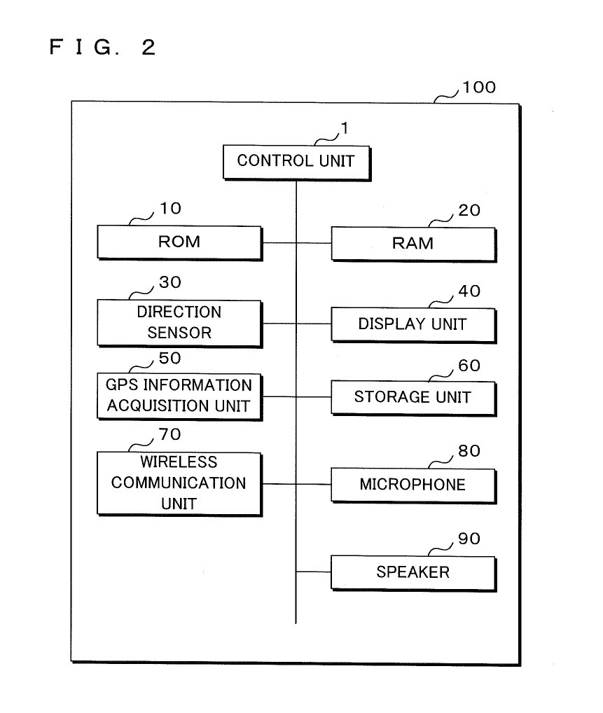

FIG. 2 is a functional block diagram illustrating a configuration of main parts of the communication terminal 100 of the communication system S according to Embodiment 1 of the present invention. The communication terminal 100 of the communication system S according to the present invention includes a control unit 1, a ROM 10, a RAM 20, a direction sensor 30, a display unit 40, a GPS information acquisition unit 50, a storage unit 60, a wireless communication unit 70, a microphone 80, and a speaker 90.

The ROM 10 is basically pre-stored with various control programs, fixed data among parameters for operation, and the like, and the RAM 20 temporarily may store data and read the data irrespective of a storage order, a storage location and the like. Further, the RAM 20 stores, for example, programs read by the ROM 10, various data generated by running the programs, parameters appropriately changed at the time of running and the like.

The direction sensor 30 has sensors (not illustrated), such as an acceleration sensor, a geomagnetic sensor, and a gyro sensor of well-known art, and specifies a direction of its own terminal (the communication terminal 100). That is, the direction sensor 30 detects a direction to which its own terminal faces. For example, the geomagnetic sensor detects geomagnetism in front and back directions and left and right directions so as to specify a north direction, and the direction sensor 30 process a signal depending on a result detected by the geomagnetic sensor, generate direction information which indicates a direction to which the communication terminal 100 faces, and output the generated direction information to the control unit 1.

The display unit 40 includes display panels such as an LCD and an electroluminescence (EL) panel and visually displays a “position relation” to be described below. For example, the display unit 40 includes a processor such as a digital signal processor (DSP) and controls an image display on the display panel. Further, the display surface of the display unit 40 is provided with a touch panel.

Therefore, a user performs a touch operation of the display surface to be able to detect a predetermined position on the display surface. For example, the touch panel detects a change in pressure due to the touch operation of a finger tip of the user or detects an electrical signal due to static electricity, detects coordinates of the display surface corresponding to positions touched by the finger tip of the user, and generates signals specifying the coordinates. Further, the touch panel may be configured to be operated by a pointing device (for example, stylus pen) and the like.

The GPS information acquisition unit 50 acquires information indicating a current position of its own terminal (the communication terminal 100). That is, the GPS information acquisition unit 50 receives a GPS signal transmitted from a GPS satellite using a GPS antenna (not illustrated) and performs predetermined signal processing. The GPS signal is output to the control unit 1 and the control unit 1 performs positioning processing based on the received GPS signal to calculate a latitude and a longitude as the current position information on its own terminal. For convenience of explanation, the case in which the GPS signal is received from one GPS satellite is described herein, but actually to position the current position, there is a need to receive the GPS signals from three or more GPS satellites.

The storage unit 60 includes a non-volatile memory medium such as a flash memory and is stored with, for example, an IP address, a MAC address, and the like of the other communication terminals 200, 300, 400, 500, and 600 which are connected to each other through the network. Further, the storage unit 60 is stored with applications which are associated with functions of the communication terminal 100. Further, the storage unit 60 is stored with a threshold distance which is used to specify a target communication terminal by a target specification unit 6 to be described below.

The wireless communication unit 70 is connected to the antenna (not illustrated) and may be wirelessly connected with the other communication terminals 200, 300, 400, 500, and 600 through the network. In addition, the wireless communication unit 70 provides a notification to the other communication terminals 200, 300, 400, 500, and 600 within the network by broadcasting. Further, the present invention is not limited to the case in which the wireless communication unit 70 is wirelessly connected with the other communication terminals 200, 300, 400, 500, and 600, but the wireless communication unit 70 may be connected therewith in a wired manner.

In connection with a voice or a sound input through the microphone 80, an analog voice signal is converted into a digital voice signal by an A/D converter (not illustrated). Further, the digital voice signal to be output to the outside is converted into the analog voice signal by a D/A converter (not illustrated) and is output through the speaker 90.

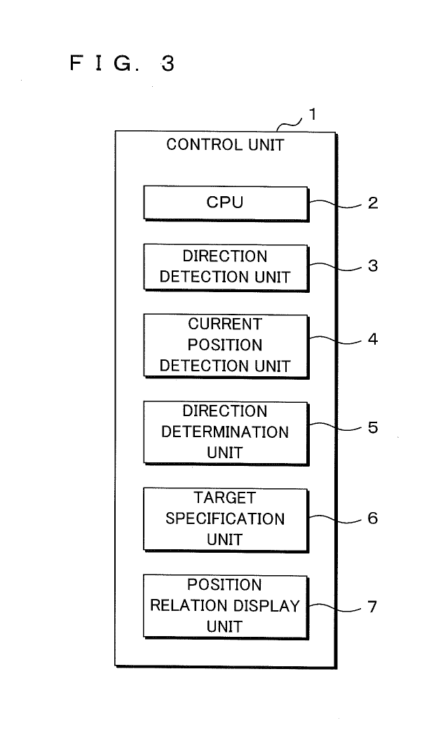

FIG. 3 is a functional block diagram illustrating a configuration of main parts of the control unit 1 in the communication terminal 100 of the communication system S according to Embodiment 1 of the present invention. The control unit 1 includes a CPU 2, a direction detection unit 3, a current position detection unit 4, a direction determination unit 5, a target specification unit 6, and a position relation display unit 7 (position relation display control unit).

The CPU 2 loads a control program pre-stored in the ROM 10 onto the RAM 20 and runs the control program to control various types of the above-described hardware and operate the entire apparatuses as the communication terminal 100 according to the present invention. Further, the CPU 2 may receive an instruction and a selection of predetermined processing from the user through the touch panel.

Further, when the CPU 2 acquires “current position information” to be described below from the other communication terminals 200, 300, 400, 500, and 600 within the network through the wireless communication unit 70, the CPU 2 calculates a distances to the other corresponding communication terminals based on the acquired current position information on the other communication terminals and the current position information on its own terminal.

As described above, the direction detection unit 3 acquires the direction information related to a detection result from the direction sensor 30 and detects a direction to which its own terminal (the communication terminal 100) faces based on the direction information acquired from the direction sensor 30.

The current position detection unit 4 detects its own current position using the GPS signal acquired by the GPS information acquisition unit 50. In more detail, the current position detection unit 4 performs the positioning processing based on the GPS signal output from the GPS information acquisition unit 50 to calculate a latitude and a longitude, thereby detecting information (current position information) on a position at which its own terminal is located.

The target specification unit 6 specifies a communication terminal (hereinafter, referred to as a target communication terminal) which is to be a target to communicate with its own terminal. That is, the target specification unit 6 specifies a candidate of the communication terminal as a communication partner which may communicate with its own terminal. The target specification unit 6 specifies the target communication terminal based on the distance to the corresponding communication terminal calculated by the CPU 2 and the direction determined by the direction determination unit 5.

In more detail, the target specification unit 6 specifies a communication terminal as the target communication terminal, which is located in the direction determined by the direction determination unit 5 and within a threshold distance stored in the storage unit 60 based on the distance from its own terminal calculated by the CPU 2.

The direction determination unit 5 determines a specific direction. In detail, when the direction to which its own terminal faces is detected by the direction detection unit 3, the direction determination unit 5 determines the detected direction, that is, the direction to which its own terminal faces as the specific direction. As described above, the target specification unit 6 specifies the target communication terminal by using a direction range based on a vector direction shown by the direction determined by the direction determination unit 5 and a predetermined angle range, for example.

The position relation display unit 7 displays the relation between the direction and the distance between the target communication terminal specified by the target specification unit 6 and its own terminal on the display surface of the display unit 40. In more detail, the position relation display unit 7 visually displays the position relation between the target communication terminal specified by the target specification unit 6 and its own terminal by using the distance to the corresponding communication terminal calculated by the CPU 2 and the direction determined by the direction determination unit 5.

For example, when the plurality of target communication terminals are specified by the target specification unit 6, the position relation display unit 7 displays each of the target communication terminals by giving different colors thereto depending on the distances from its own terminal. Hereinafter, for convenience of explanation, the relation between the direction and the distance between the target communication terminal and its own terminal is simply referred to as a “position relation”.

Similar to the communication terminal 100 of the communication system S, each of the other communication terminals 200, 300, 400, 500, and 600 within the network also includes the GPS information acquisition unit and the direction sensor and is configured to be able to acquire the current position information on its own terminal and detect the direction. Further, similar to the communication terminal 100 of the communication system S, each of the other communication terminals 200, 300, 400, 500, and 600 includes the control unit, which includes the CPU, the direction detection unit, the current position detection unit, the direction determination unit, the target specification unit, and the position relation display unit. Operation of these units is the same as that of the communication terminal 100 and therefore a detailed description thereof will be omitted.

In the communication system S according to Embodiment 1 of the present invention, the communication terminal 100 and the other communication terminals 200, 300, 400, 500, and 600 have the above-described configuration and therefore may acquire the current position information on other communication terminals through the network. The CPU 2 calculates the distance to the corresponding communication terminal using the current position information acquired from the other communication terminals 200, 300, 400, 500, and 600, and as described above, the target specification unit 6 specifies the target communication terminal. Hereinafter, the processing thereof will be described in detail.

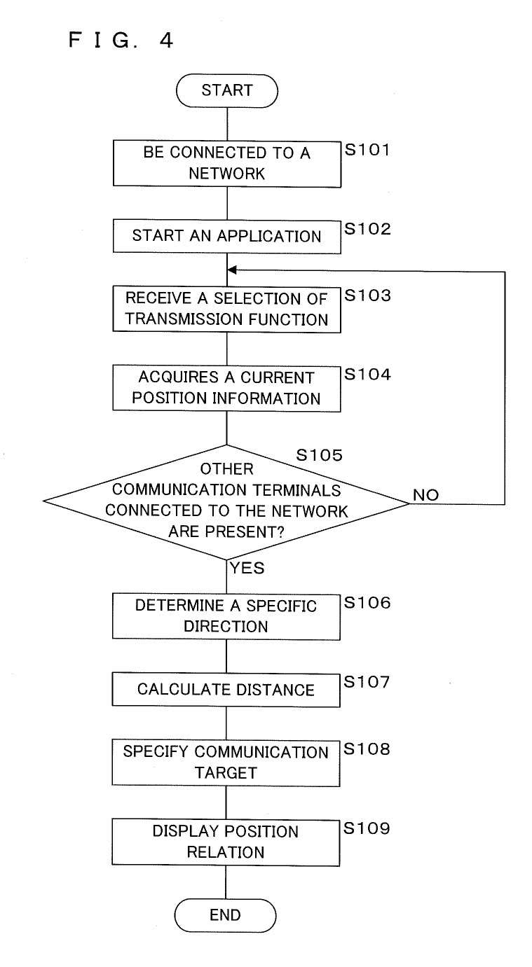

FIG. 4 is a flow chart illustrating processing associated with specifying a target communication terminal and displaying the position relation with the target communication terminal in the communication terminal 100 of the communication system S according to Embodiment 1 of the present invention. Hereinafter, for convenience of explanation, the case in which the user of the communication terminal 100 transmits document data to any of the other communication terminals through the network will be described by way of example.

First, the wireless communication unit 70 is connected to the network (step S101). Then, the user appropriately operates the communication terminal 100 to select applications concerning the transmission of the document data.

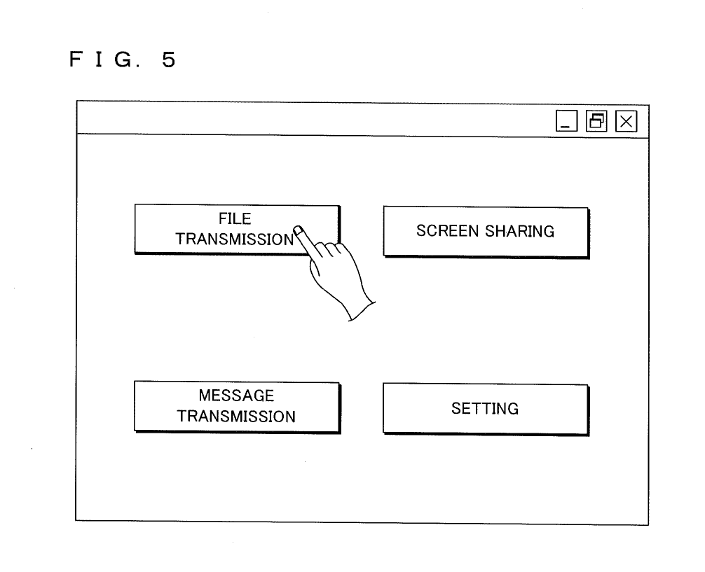

The CPU 2 receives the selection from the user and starts the application selected by the user (step S102). Thereafter, for example, a “data transmission function selection screen” is displayed on the display surface of the display unit 40. FIG. 5 is an exemplified diagram illustrating an example of the data transmission function selection screen displayed on the communication terminal 100 of the communication system S according to Embodiment 1 of the present invention. Soft keys for “file transmission”, “screen sharing”, “message transmission”, and “setting” are displayed on the data transmission function selection screen illustrated in FIG. 5. The user appropriately operates the soft keys on the display surface (touch panel) of the display unit 40 to be able to select any one of the transmission functions. Hereinafter, the case in which the soft key for “file transmission” is operated will be described by way of example.

In this case, the CPU 2 receives the selection of any one of the transmission functions through the touch panel. According to the present embodiment, the CPU 2 receives the selection of the transmission function of the “file transmission” (step S103).

Next, the CPU 2 acquires the current position information on the other communication terminals which are connected to the network through the wireless communication unit 70 (step S104). For example, the CPU 2 transmits a broadcast packet which was requested so as to transmit the current position information concerning their own terminal to the other communication terminals, respectively, through the wireless communication unit 70.

In response to the request from the communication terminal 100, the other communication terminals connected to the network transmit the current position information regarding their own terminal based on the GPS signal acquired by the GPS information acquisition unit provided in their own terminal to the communication terminal 100. The CPU 2 acquires the current position information regarding the other communication terminals through the wireless communication unit 70 and stores the acquired current position information in the RAM 20.

The CPU 2 confirms whether the current position information from the other communication terminals is received, and thereby determines whether other communication terminals connected to the corresponding network are present (step S105).

At this time, if the current position information is not received from any other communication terminal, the CPU 2 determines that other communication terminals connected to the corresponding network are not present (NO in step S105) and the processing returns to step S103.

Meanwhile, when the current position information is received from any other communication terminal, the CPU 2 determines that other communication terminals connected to the corresponding network are present (YES in step S105). In this case, the direction determination unit 5 determines a specific direction (step S106). The determination of the specific direction by the direction determination unit 5 is performed based on the detection result of the direction of its own terminal by the direction detection unit 3 and the details thereof are already described, therefore a description thereof will be omitted herein. Hereinafter, the specified direction determined by the direction determination unit 5 is defined as a “north direction”.

Next, the CPU 2 calculates each distance to the other communication terminals using the current position information regarding each of the other communication terminals acquired in step S104 and the current position information on its own terminal (the communication terminal 100) (step S107). The calculated distance is associated with the other corresponding communication terminals and stored in the RAM 20.

In this case, the target specification unit 6 specifies the target communication terminal which may be a communication target with its own terminal (the communication terminal 100) (step S108). The target specification unit 6 specifies the target communication terminal based on the distance to the corresponding communication terminal calculated by the CPU 2 and the direction determined by the direction determination unit 5. Specifying the target communication terminal by the target specification unit 6 is already described and therefore a detailed description thereof will be omitted.

Next, the position relation display unit 7 displays the position relation, that is, the relation between direction and distance between the target communication terminal specified by the target specification unit 6 and its own terminal on the display surface of the display unit 40 (step S109). This will be described below in detail. For convenience of explanation, it is assumed that, in step S104, the current position information regarding each of the communication terminals was acquired from all the other communication terminals 200, 300, 400, 500, and 600, and the other communication terminals are each recognized by terminal names of A, B, C, D, and E in the communication terminal 100.

For example, when the communication terminals 200, 300, and 400 are specified as the target communication terminals by the target specification unit 6 in step S108, the position relation with its own terminal is visually displayed by using a radius of the threshold distance, the distances to the communication terminals 200, 300, and 400 calculated by the CPU 2 in step S107, and the direction determined by the direction determination unit 5 in step S106.

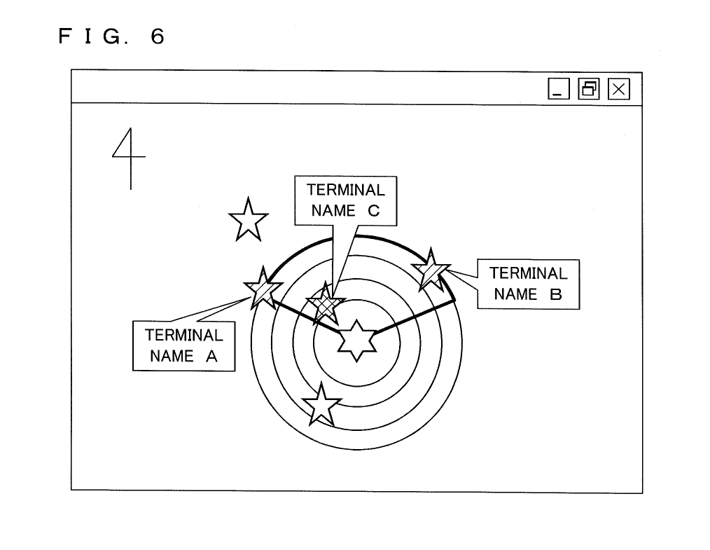

FIG. 6 is an exemplified diagram illustrating an example of the position relation displayed by the position relation display unit 7 in the communication terminal 100 of the communication system S according to Embodiment 1 of the present invention. FIG. 6 illustrates a difference in color by making hatching patterns different.

In FIG. 6, the other communication terminals are represented by an asterisk and the communication terminals 200, 300, and 400 specified as target communication terminals are associated with colors different from those of the communication terminals 500 and 600. Further, even in the case of displaying the communication terminals 200, 300, and 400, other colors are given depending on the distance from the communication terminal 100.

therefore, the distance between the other communication terminals (target communication terminals), which are located in the direction determined by the direction determination unit 5 in step S106 and within the radius of the threshold distance, and its own terminal (the communication terminal 100) may be seen at a glance.

The communication system S according to the present invention has the above-described configuration and therefore the user may easily select a communication terminal of the communication partner to be communicated therewith and prevent an error, such as unintendedly transmitting data to others by mistake.

### Embodiment 2

Embodiment 1 of the present invention describes, by way of example, the case in which the position relation display unit 7 illustrates the position relation by a diagram, but the present invention is not limited thereto. According to Embodiment 2, the position relation display unit 7 displays the position relation by a table.

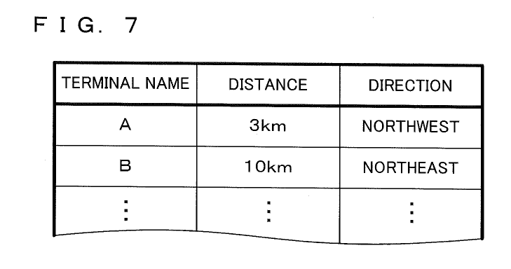

FIG. 7 is an exemplified diagram illustrating an example of the position relation displayed by the position relation display unit 7 in the communication terminal 100 of the communication system S according to Embodiment 2 of the present invention. In FIG. 7, on the base of its own terminal (the communication terminal 100), items of the distances to each of the target communication terminals and the directions are prepared for each of the target communication terminals (terminal names) and the position relation with each target communication terminal is displayed by the table.

Therefore, the user may easily select the communication terminal of the communication partner to be communicated therewith and prevent an error, such as unintendedly transmitting data to others by mistake.

The above-described direction detection unit 3, the current position detection unit 4, the direction determination unit 5, the target determination unit 6, and the position relation display unit 7 may be built with hardware logic and may be built in software wherein the CPU 2 runs the related predetermined programs.

Further, the configuration of the communication system S according to the present invention is not limited to the above description. For example, when a user wants to communicate with ones other than target communication terminals and selects, as the destination, a terminal other than the communication terminals specified as target communication terminals, the communication system S may be configured to display a predetermined warning or produce a warning sound.

Further, the present invention is not limited thereto, but for example, even when the user wants to transmit data to the farthest target communication terminal as a destination, the communication system may be configured to display a predetermined warning or produce a warning sound.

Further, in the above description, the case in which the wireless communication between the communication terminals is made is described by way of example, but the configuration of the communication system S according to the present invention is not limited to the above description. A case in which wired communication between the communication terminals is made may be also applied.

Further, in the above description, the case in which the communication terminal 100 is a so-called mobile phone is described by way of example, but the configuration of the communication system S according to the present invention is not limited to the above description, and the communication terminal 100 may be PDAs, such as a notebook computer, a tablet or the like.

Further, in the above description, the example in which the target specification unit 6 specifies the target communication terminal based on the distance to the corresponding communication terminal calculated by the CPU 2, the direction determined by the direction determination unit 5, and the threshold distance is described, but the present invention is not limited thereto. For example, the communication system may be configured to specify the target communication terminal only based on the direction determined by the direction determination unit 5.

According to the present invention, there is provided a communication system S including a plurality of communication terminals 100, 200, 300, 400, 500 and 600 having their own position information and performing communication between the communication terminals, wherein one communication terminal 100 includes: a direction determination unit 5 configured to determine a specific direction; and a target specification unit 6 configured to specify a target communication terminal which is to be a communication target with its own terminal, based on the determined direction and position information of other communication terminals acquired from the other communication terminals 200, 300, 400, 500 and 600.

According to the present invention, in the one communication terminal, the direction determination unit determines a specific direction, and the target specification unit specifies a target communication terminal which is to be a communication target with its own terminal, based on the determined direction and position information of other communication terminals acquired from the other communication terminals, thereby enabling a user to easily select a communication terminal of a communication partner to be communicated therewith, preventing an error, such as unintendedly transmitting data to others by mistake, alleviating a burden on an operation of selecting the communication terminal of the communication partner to be communicated therewith, and more intuitively operating the communication terminal.

The communication system according to the present invention is characterized in that, the one communication terminal 100 includes a direction detection unit 3 configured to detect a direction of its own terminal, and the direction determination unit 5 determines a direction based on a result detected by the direction detection unit.

According to the present invention, in the one communication terminal, the direction determination unit determines a direction based on a result detected by the direction detection unit, and the target specification unit specifies a target communication terminal which is to be a communication target, based on the determined direction and position information from the other communication terminals, thereby alleviating a burden on an operation of selecting the communication terminal of the communication partner to be communicated therewith.

The communication system according to the present invention is characterized in that, the one communication terminal 100 includes a calculation unit 2 configured to calculate the distance to the other communication terminals 200, 300, 400, 500 and 600 based on the position information from the other communication terminals 200, 300, 400, 500 and 600, and the target specification unit 6 specifies the target communication terminal based on the distance calculated by the calculation unit 2, the direction determined by the direction determination unit 5, and the position information from the other communication terminals 200, 300, 400, 500 and 600.

According to the present invention, in the one communication terminal, when the distance to the other communication terminals is calculated by the calculation unit, the target specification unit specifies the target communication terminal based on the distance calculated by the calculation unit, the direction determined by the direction determination unit, and the position information from the other communication terminals, thereby the target communication terminal may be more easily specified.

The communication system according to the present invention is characterized in that, the one communication terminal 100 includes a display unit 40, a position relation display control unit 7 configured to display a relation between direction and distance between the target communication terminal specified by the target specification unit 6 and its own terminal on the display unit 40.

According to the present invention, in the one communication terminal, the position relation display control unit displays a relation between direction and distance between the target communication terminal specified by the target specification unit and its own terminal on the display unit, thereby enabling a user to easily select a communication terminal of a communication partner to be communicated therewith, preventing an error, such as unintendedly transmitting data to others by mistake, alleviating a burden on an operation of selecting the communication terminal of the communication partner to be communicated therewith, and more intuitively operating the communication terminal.

The communication system according to the present invention is characterized in that, in the one communication terminal 100, when a plurality of target communication terminals are specified by the target specification unit 6, the position relation display control unit 7 displays each of the target communication terminals by associating different colors thereto depending on the distances from its own terminal.

According to the present invention, in the one communication terminal, when the plurality of target communication terminals are specified by the target specification unit, the position relation display control unit displays each of the target communication terminals by associating different colors thereto depending on the distances from its own terminal, thereby enabling a user to easily select a communication terminal of a communication partner to be communicated therewith, preventing an error, such as unintendedly transmitting data to others by mistake.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A communication system including a plurality of communication terminals having their own position information and performing communication between the communication terminals, wherein one communication terminal comprises:
a direction determination unit configured to determine a specific direction; and
a target specification unit configured to specify a target communication terminal which is to be a communication target with its own terminal, based on the determined direction and position information of other communication terminals acquired from the other communication terminals.

2. The communication system according to claim 1, wherein the one communication terminal comprises a direction detection unit configured to detect a direction of its own terminal, and
the direction determination unit determines a direction based on a result detected by the direction detection unit.

3. The communication system according to claim 1, wherein the one communication terminal comprises a calculation unit configured to calculate the distance to the other communication terminals based on the position information from the other communication terminals, and
the target specification unit specifies the target communication terminal based on the distance calculated by the calculation unit, the direction determined by the direction determination unit, and the position information from the other communication terminals.

4. The communication system according to claim 3, wherein the one communication terminal comprises a position relation display control unit configured to display a relation between direction and distance between the target communication terminal specified by the target specification unit and its own terminal.

5. The communication system according to claim 4, wherein the position relation display control unit displays the target communication terminal by associating colors thereto among the other communication terminals.

6. The communication system according to claim 5, wherein in the one communication terminal, when a plurality of target communication terminals are specified by the target specification unit, the position relation display control unit displays each of the target communication terminals by associating different colors thereto depending on the distances from its own terminal.

7. The communication system according to claim 1, wherein when the one communication terminal receives a selection of a communication terminal other than the target communication terminals as the communication terminal to be communicated therewith, the one communication terminal notifies the effect thereof.

8. A specification method of allowing one communication terminal to specify a target communication terminal which is to be a communication target therewith, in a communication system include [symbol]
ing a plurality of communication terminals having their own position information and performing communication between the communication terminals, the specific method comprising:
a step of determining a specific direction; and
a step of specifying the target communication terminal concerning its own terminal, based on the determined direction and position information of other communication terminals acquired from the other communication terminals.

9. A non-transitory computer-readable recording medium recorded with a computer program which causes to specify a target communication terminal which is to be a communication target with one communication terminal, the computer constituting a communication system including a plurality of communication terminals having their own position information and performing communication between the communication terminals, the computer program comprising:
a step of determining a specific direction by the computer; and
a step of specifying the target communication terminal concerning its own terminal, based on the determined direction and position information of other communication terminals acquired from the other communication terminals by the computer.
